(19) United States
(12) Patent Application Publication
(10) Pub. No.: US 2023/0348175 A1
(43) Pub. Date: Nov. 2, 2023

(54) Infusion Water Bottle

(71) Applicant: Kumud Verma, Revere, MA (US)

(72) Inventor: Kumud Verma, Revere, MA (US)

(21) Appl. No.: 17/734,076

(22) Filed: May 1, 2022

(51) Int. Cl. B65D 85/804; A23L 2/56

(52) U.S. Cl. CPC B65D 85/8043; A23L 2/56

(57) ABSTRACT

An infusion water bottle is disclosed. The infusion water bottle comprises a body comprising a neck portion and an open end at a top portion for allowing a liquid to flow in and out of the infusion water bottle and a removable closure threadably secured to the top portion of the body for sealing the open end of the body. The infusion water bottle further comprises an infuser configured to be removably secured to a bottom portion of the body and receive a flavoring material. The infusion water bottle comprises a plurality of openings to permit the liquid to enter and exit from the infuser, thereby infusing flavors from the flavoring material into the liquid. The infusion water bottle further comprises a base configured to be removably secured to the bottom portion of the body and received the infuser for allowing the liquid to enter and exit the infuser.

### BACKGROUND OF THE INVENTION

### Technical Field

The present disclosure is primarily related to an infusion water bottle and in particular related to an infusion water bottle for making infused beverages and allowing an individual to maintain hydration levels, thereby helping in maintaining a healthy lifestyle.

### Description of the Related Art

A healthy lifestyle is a way of living that an individual maintains to lower the risk of diseases, stay fit, and increase or maintain immunity towards infections such as COVID 19 and Flu. World Health Organization (WHO) defines health as “a complete state of mental, physical, and social well-being not merely the absence of disease”. People could maintain a healthy lifestyle by:
i) eating a balanced diet and limiting unhealthy foods, exercising regularly, and opting for nutritious meals high in protein and fiber, and low in fat, sugar, and calories;
ii) taking multivitamin supplements if the requisite amount of nutrients is not available through a natural diet and ensuring that the body is not deficient in vitamins such as A, B6, B12, C, D, and E, and micronutrients such as zinc, iron, copper, selenium, and magnesium; and
iii) drinking water for staying hydrated and limiting sugar beverages.

Over the past few years, rapid expansion in several relevant scientific fields and, in particular, the number of population-based epidemiological evidence has helped to clarify the role of diet in preventing and controlling morbidity, and premature mortality resulting from non-communicable diseases (NCDs). Some of the specific dietary components increase the probability of occurrence of these diseases in individuals, and interventions to modify their impact, have also been identified.

Human body has evolved to adapt to a certain kind of environment, and it stands to reason that human health is inextricably linked to its surrounding environment. Furthermore, rapid changes in diet and lifestyles have occurred with industrialization, urbanization, economic developments, and market globalization. However, our understanding of the environmental effects on health is still an area of study. All that is having a significant impact on the health and nutrition of the population, particularly in developing countries and in countries in transition. While standards of living have improved, food availability has expanded and become more diversified, and access to services has increased, there have also been significant negative consequences in terms of inappropriate dietary patterns, decreased physical activities and increased tobacco use, and a corresponding increase in diet-related chronic diseases, especially among poor people.

Food and food products have become commodities produced and traded in a market that has expanded from an essentially local base to an increasingly global one. Changes in the world food economy are reflected in shifting dietary patterns, for example, increased consumption of energy-dense diets high in fat, particularly saturated fat, and low in unrefined carbohydrates. These patterns are combined with a decline in energy expenditure that is associated with a sedentary lifestyle, motorized transport, labor-saving devices in the home, phasing out of physically demanding manual tasks in the workplace, and leisure time that is preponderantly devoted to physically undemanding pastimes.

Because of these changes in dietary and lifestyle patterns, chronic NCDs and diseases including obesity, diabetes, cardiovascular disease (CVD), hypertension and stroke, and cancer are becoming increasingly significant causes of disability and premature death in both developing and newly developed countries, placing additional responsibility on national health resources.

Despite being one of the most prevalent materials on the planet, plastic and its impact on human health are still under study. Yet exposure to plastic is expanding into new areas of the environment and food chain as existing plastic products (for example, plastic containers and water bottles) fragment into smaller particles and concentrate toxic chemicals. Ordinarily, plastic products are manufactured using industrial chemicals, for example, bisphenol A (BPA), which is majorly used in the manufacture of polycarbonate and epoxy resins. Currently, bisphenol F (BPF) and bisphenol S (BPS) are replacing bisphenol A (BPA) in the manufacturing of such products. Data on current human exposure levels of these substitutes is required to understand the negative impact on human health and risks posed.

Although BPS has been a favored replacement for BPA because it was believed to be more resistant to leaching, due to lack of substantial toxicological data in support of use of bisphenol S, it has not been able to successfully replace bisphenol A. In the absence of safer alternatives to bisphenol A, a polymer resin material, Tritan®, a product from Eastman Chemical Company, which is a BPA-free plastic is being considered as an alternative to polycarbonates as a food-grade material.

Australian patent application AU2015100312A4 teaches a flavored twister's/chilli twister flavored infused bottle tops/caps. It provides for a seal for a bottle to be provided inside the top or cap of the bottle, the seal infused with flavors to enhance a drink or beverage contained within the sealed bottle. The flavored seal offers different flavors to enhance the taste of any drink without causing any changes to the contents of the beverage.

The Chinese patent application CN107416364A teaches a method to prepare beverages with a longer shelf life. The beverage is stored in solid form on the inside of the cap while the bottle stores potable water. When a user is ready to drink the beverage, their action of opening the cap induces the solid beverage to mix and get dissolved in the water to prepare a drinkable beverage.

WO2009140855A1 teaches a beverage bottle comprising a bottle body containing drinking water and a cap mounted on the mouth of the bottle body. The cap comprises a top cap, a cylinder support, and a storage cylinder containing a beverage concentrate. The top cap is threadably coupled to the cylinder support and the cylinder support is threadably engaged to the bottle mouth. The storage cylinder is simultaneously coupled to the top cap and the cylinder support. The sealing film on the storage cylinder is pierced by the cylinder support when the top cap is rotated, thereby adding the beverage concentrate into the drinking water. The cylinder support can be screwed off the mouth of the bottle in order to directly drink the water stored in the beverage bottle. The user can selectively drink water or mixed beverage.

There has been a long-standing requirement for designing an infusion water bottle to prepare infused beverages and allowing an individual not only to maintain hydration levels but also infuse nutrients at the same time.

### SUMMARY OF THE INVENTION

In an embodiment of the present disclosure, there is provided an infusion water bottle. In one embodiment, the infusion water bottle is configured to enable an individual or a user for making infused beverages or flavored liquids for consumption. The infusion water bottle is an environment friendly container for liquids that is designed to make infused beverages and, upon disassembly, may easily be separated for cleaning with minimal effort and dishwasher safe. The infusion water bottle could be a container, such as, but not limited to, a pitcher, a jug, and a cup. In one embodiment, the infusion water bottle is made of a material, but not limited to, a polymer resin. In an alternative embodiment of the present invention, the infusion water bottle is made of a material comprising at least one of Tritan®, silicone, and stainless steel.

In one embodiment, the infusion water bottle comprises a body, a removable closure or a cap, an infuser, and a base. In one embodiment, the body comprises a neck portion and an open end at a top portion for allowing a liquid to flow in and out of the infusion water bottle. In one embodiment, the removable closure is configured to removably secure to the top portion for closing or sealing the open end of the body. In one embodiment, the infuser is configured to removably secure to a bottom portion of the body of the infusion water bottle. In one embodiment, the base is configured to be removably secured to the bottom portion of the body. In one embodiment, the base is further configured to receive the infuser and secure to the body of the infusion water bottle.

In one embodiment, the base comprises a wall extending upwardly from a lower end of the base. The base is further configured to provide stability and support for the infusion water bottle in an upstanding manner on a horizontal support surface. In one embodiment, the removable closure comprises a strap or a belt for enabling the user to hold the infusion water bottle. The strap is securely affixed to the top portion of the removable closure. The user could easily lift and carry the infusion water bottle by simply holding the strap.

In one embodiment, the neck portion of the body comprises a plurality of threads for releasably securing the removable closure, thereby sealing the open end of the body of the infusion water bottle. In one embodiment, the infuser is configured to receive a flavoring material, thereby infusing flavors from the flavoring material into the liquid stored in the infusion water bottle. In one embodiment, the flavoring material comprises at least one additive selected from the group including natural flavors, nature-identical flavors, and artificial flavors. In another embodiment, the flavoring material comprises at least one additive selected from the group including pieces of fruits and vegetables. Particularly preferred flavors include citrus flavors such as, but not limited to, orange flavor, lemon flavor, lime flavor, and grapefruit flavor. In addition to such citrus flavors, various other flavors such as green tea, apple, grape, raspberry, cranberry, cherry, and pineapple flavors are also used.

In one embodiment, the infuser comprises a flange and a wall portion defined by a plurality of openings. The wall portion is extended downwardly from the flange and the plurality of openings permits the liquid to enter and exit from the infuser, thereby infusing flavors from the flavoring material into the liquid. In one embodiment, the flange comprises a plurality of threads annularly for threadably securing to an inner surface of the bottom portion of the body. In one embodiment, the infuser comprises, but is not limited to, a cone structure.

In one embodiment, the base comprises a plurality of threads annularly formed around the opening top of the base for threadably engaging to an outer surface of the bottom portion of the body of the infusion water bottle. In some embodiments, the base comprises a locking groove annularly formed around the opening top of the base for securing to the bottom portion of the body of the infusion water bottle.

### BRIEF DESCRIPTION OF DRAWINGS

The illustrated embodiments of the subject matter will be best understood by reference to the drawings, wherein like parts are designated by like numerals throughout. The following description is intended only by way of example, and simply illustrates certain selected embodiments of devices, systems, and processes that are consistent with the subject matter as claimed herein.

FIG. 1 illustrates a side view of an infusion water bottle, according to one embodiment of the present disclosure;

FIG. 2 illustrates a top perspective view of the infusion water bottle comprising an infuser, according to one embodiment of the present disclosure;

FIG. 3 illustrates a bottom view of a base of the infusion water bottle, according to one embodiment of the present disclosure;

FIGS. 4-5 illustrate a side view and a side perspective view of the infusion water bottle comprising a strap, according to one embodiment of the present disclosure; and

FIG. 6 illustrates an exploded view of the infusion water bottle, according to one embodiment of the present disclosure.

### DETAILED DESCRIPTION OF THE EMBODIMENTS

The following description is presented to enable any person skilled in the art to make and use the invention as claimed and is provided in the context of the particular examples discussed below, variations of which will be readily apparent to those skilled in the art. In the interest of clarity, not all features of an actual implementation are described in the given specification. It will be appreciated that in the development of any such actual implementation (as in any development project), design decisions must be made to achieve the designers' specific goals (e.g., compliance with system- and business-related constraints), and that these goals will vary from one implementation to another.

Example apparatus are described herein. Other example embodiments or features may further be utilized, and other changes may be made, without deviating from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

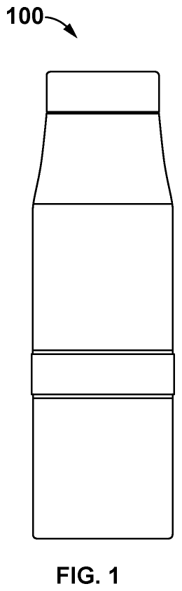

Referring to FIG. 1, an infusion water bottle 100, according to one embodiment of the present invention is disclosed. In one embodiment, the infusion water bottle 100 is configured to enable an individual or a user for making infused beverages or flavored liquids for consumption. The infusion water bottle 100 is an environmentally friendly container for liquids that is designed to make infused beverages and, upon disassembly, may easily be separated for cleaning with minimal effort. The infusion water bottle 100 could be a container, such as, but not limited to, a pitcher, a jug, and a cup. In one embodiment, the infusion water bottle 100 is made of a material, but not limited to, a polymer resin. In an alternative embodiment of the present invention, the infusion water bottle 100 is made of a material comprising at least one of Tritan®, silicone, and stainless steel. Tritan® is a bisphenol A (BPA) free plastic and does not use other bisphenol compounds such as bisphenol S (BPS) either.

The infusion water bottle 100 assists the user to stay hydrated while maintaining a healthy lifestyle. It is a more holistic and natural approach to increasing immunity, weight management, and achieving better skin, hair, and nails for the user who adopts the healthy lifestyle. The infusion water bottle 100 is a more sophisticated approach to provide the infused hydration requirement for modern lifestyle for the user.

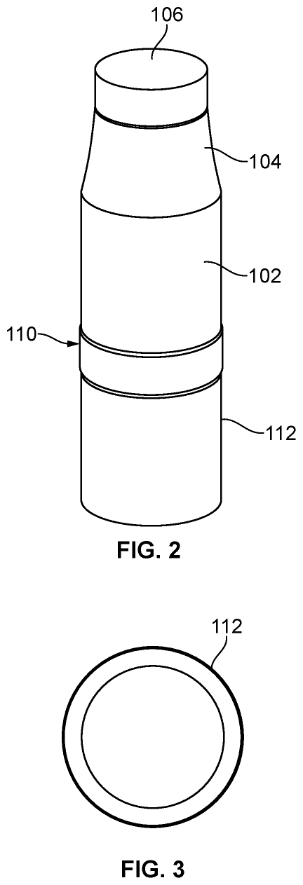

Referring to FIG. 2, the infusion water bottle 100 comprising an infuser 110, according to one embodiment is disclosed. In one embodiment, the infusion water bottle 100 comprises a body 102, a removable closure or a cap 106, an infuser 110, and a base 112. In one embodiment, the body 102 comprises a neck portion 104 and an open end at a top portion for allowing a liquid to flow in and out of the infusion water bottle 100. In one embodiment, the removable closure 106 is configured to removably secure to the top portion for closing or sealing the open end of the body 102. In one embodiment, the infuser 110 is configured to removably secure to a bottom portion of the body 102 of the infusion water bottle 100. In one embodiment, the base 112 is configured to be removably secured to the bottom portion of the body. In one embodiment, the base 112 is further configured to receive the infuser 110 and secure to the body 102 of the infusion water bottle 100.

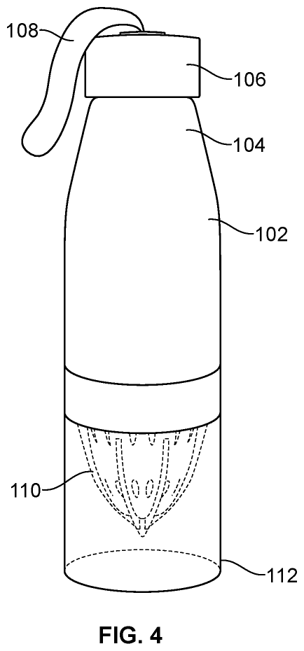

Referring to FIG. 3, the base 112 of the infusion water bottle 100, according to one embodiment is disclosed. In one embodiment, the base 112 comprises a wall extending upwardly from a lower end of the base 112. The base 112 is further configured to provide stability and support for the infusion water bottle 100 in an upstanding manner on a horizontal support surface.

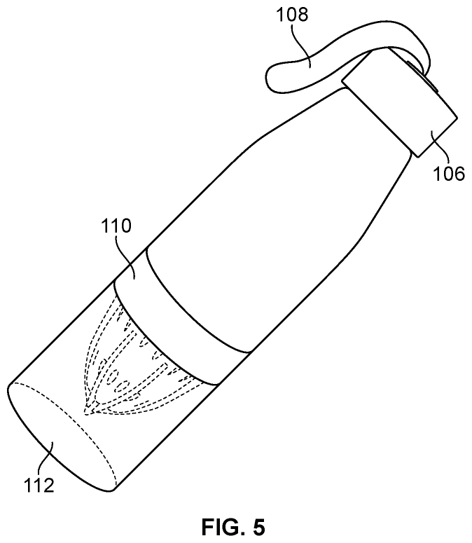

Referring to FIGS. 4-5, the infusion water bottle 100, according to one embodiment of the present invention is disclosed. In one embodiment, the removable closure 106 comprises a strap or a belt 108 for enabling the user to hold the infusion water bottle 100. The strap 108 is securely affixed to the top portion of the removable closure 106. The user could easily lift and carry the infusion water bottle 100 by simply holding the strap 108. The infusion water bottle 100 could be designed with an environment-conscious approach. The infusion water bottle 100 could be recyclable, sustainable, and reusable, thereby reducing carbon footprint and helping in environmental protection.

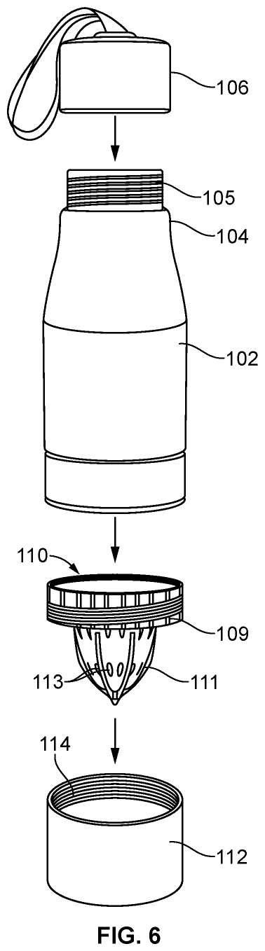

Referring to FIG. 6, an exploded view of the infusion water bottle 100, according to one embodiment of the present invention disclosed. In one embodiment, the neck portion 104 of the body 102 comprises a plurality of threads 105 for releasably securing the removable closure 106, thereby sealing the open end of the body 102 of the infusion water bottle 100. In one embodiment, the infuser 110 is configured to receive a flavoring material, thereby infusing flavors from the flavoring material into the liquid stored in the infusion water bottle 100. In one embodiment, the flavoring material comprises at least one additive selected from the group including natural flavors, nature-identical flavors, and artificial flavors. In another embodiment, the flavoring material comprises at least one additive selected from the group including pieces of fruits and vegetables. Particularly preferred flavors include citrus flavors such as, but not limited to, orange flavor, lemon flavor, lime flavor, and grapefruit flavor. In addition to citrus flavors, various other flavors such as green tea, chamomile tea, apple, grape, raspberry, cranberry, cherry, and pineapple flavors may also be used. The infused flavored water based on the choice of ingredient can be used to increase immunity, weight loss, weight management, detox, better skin and longevity.

In one embodiment, the infuser 110 comprises a flange 109 and a wall portion 111 defined by a plurality of openings 113. The wall portion 111 is extended downwardly from the flange 109 and the plurality of openings 113 permits the liquid to enter and exit from the infuser 110, thereby infusing flavors from the flavoring material into the liquid. In one embodiment, the flange 109 comprises a plurality of threads annularly for threadably securing to an inner surface of the bottom portion of the body 102. In one embodiment, the infuser 110 comprises, but is not limited to, a cone structure.

In one embodiment, the base 112 comprises a plurality of threads 114 annularly formed around the opening top of the base 112 for threadably engaging to an outer surface of the bottom portion of the body 102 of the infusion water bottle 100. In some embodiments, the base 112 comprises a locking groove annularly formed around the opening top of the base 112 for securing to the bottom portion of the body 102 of the infusion water bottle 100. In one embodiment, the infusion water bottle 100 has a capacity of, but not limited to, 20 oz. or 650 ml. In one embodiment, the infusion water bottle 100 has leak-proof design with silicone rings. In some embodiments, the infusion water bottle 100 could be manufactured in different sizes. In other embodiments, the body 102, the removable closure or the cap 106, the infuser 110, the base 112, the strap 108, and the infuser 110 of the infusion water bottle 100 are individually easy to clean and are dishwasher safe. The infusion water bottle 100 could be used for multiple purposes such as a juicer, fruit infuser, and water bottle that is suitable for traveling, at home and office, in the gym, and during sports activity. The infusion water bottle 100 is easy to use and designed to meet daily hydration requirements for the user, thereby increasing immunity against infectious diseases such as Covid 19.

It is to be understood that not necessarily all objectives or advantages may be achieved in accordance with any particular embodiment described herein. Thus, for example, those skilled in the art will appreciate that certain embodiments may be configured to operate in a manner that achieves or optimizes one advantage or group of advantages as taught herein without necessarily achieving other objects or advantages as may be taught or suggested herein.

Many other variations other than those described herein will be apparent from this disclosure. For example, depending on the embodiment, certain actions, events, or functions of any of the algorithms described herein may be performed in different sequences, and may be added, merged, or excluded altogether (e.g., not all described actions or events are required to execute the algorithm). Moreover, in certain embodiments, operations or events are performed in parallel, for example, through multithreading, interrupt handling, or through multiple processors or processor cores, or on other parallel architectures, rather than sequentially. In addition, different tasks or processes can be performed by different machines and/or computing systems that can work together.

Unless otherwise stated, conditional languages such as “can,” “could,” “will,” “might,” or “may” are understood within the context as used in general to convey that certain embodiments include, while other embodiments do not include, certain features, elements, and/or steps. Thus, such conditional languages are not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations.

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.).

For expository purposes, the term “horizontal” as used herein is defined as a plane parallel to the plane or surface of the floor of the area in which the system being described is used or the method being described is performed, regardless of its orientation. The term “floor” can be interchanged with the term “ground” or “water surface”. The term “vertical” refers to a direction perpendicular to the horizontal as just defined. Terms such as “above,” “below,” “bottom,” “top,” “side,” “higher,” “lower,” “upper,” “over,” and “under” are defined with respect to the horizontal plane.

As used herein, the terms “engaged,” “connected,” “coupled,” and other such relational terms should be construed, unless otherwise noted, to include removable, moveable, fixed, adjustable, and/or releasable connections or attachments. The connections/attachments can include direct connections and/or connections having intermediate structure between the two components discussed.

Numbers preceded by a term such as “approximately,” “about,” and “substantially” as used herein include the recited numbers, and also represent an amount close to the stated amount that still performs a desired function or achieves a desired result. For example, the terms “approximately,” “about,” and “substantially” may refer to an amount that is within less than 10% of the stated amount. Features of embodiments disclosed herein preceded by a term such as “approximately,” “about,” and “substantially” as used herein represent the feature with some variability that still performs a desired function or achieves a desired result for that feature.

It should be emphasized that many variations and modifications may be made to the above-described embodiments, the elements of which are to be understood as being among other acceptable examples. All such modifications and variations are intended to be included herein within the scope of this disclosure and protected by the following claims.

1. An infusion water bottle, comprising:
a body comprising a neck portion and an open end at a top portion for allowing a liquid to flow in and out of the infusion water bottle;
a removable closure threadably secured to the top portion of the body for sealing the open end of the body;
an infuser configured to removably secure to a bottom portion of the body and receive a flavoring material, wherein the infuser comprises:
a flange; and
a wall portion defined by a plurality of openings, wherein the wall portion is extended downwardly from the flange and the plurality of openings permits the liquid to enter and exit from the infuser, thereby infusing flavors from the flavoring material into the liquid stored in the infusion water bottle; and
a base configured to be removably secured to the bottom portion of the body, wherein the base is further configured to receive the infuser for allowing the flavored liquids to enter and exit the infuser.

2. The infusion water bottle of claim 1; wherein the base comprises a plurality of threads annularly formed around an opening top of the base for threadably engaging to an outer surface of the bottom portion of the body.

3. The infusion water bottle of claim 1, wherein the flange of the infuser comprises a plurality of threads annularly for threadably securing to an inner surface of the bottom portion of the body, thereby securing the infuser to the bottom portion of the body.

4. The infusion water bottle of claim 1, wherein the removable closure comprises a strap to enable a user for holding the infusion water bottle.

5. The infusion water bottle of claim 1, wherein the infuser is of a cone shape.

6. The infusion water bottle of claim 1, wherein the body of infusion water bottle is made of a polymer resin comprising at least one of Tritan®, silicone, and stainless steel.

7. (canceled)

8. The infusion water bottle of claim 1, wherein the flavoring material comprises at least one additive selected from the group including natural flavors of fruits and vegetables, nature-identical flavors of fruits and vegetables, artificial flavors of fruits and vegetables, and pieces of fruits and vegetables.

9. An infusion water bottle, comprising:
a body comprising a neck portion and an open end at a top portion for allowing a liquid to flow in and out of the infusion water bottle;
a removable closure threadably secured to the top portion of the body for sealing the open end of the body;
an infuser configured to removably secure to a bottom portion of the body and receive a flavoring material, wherein the infuser comprises a plurality of openings to permit the liquid to enter and exit from the infuser, thereby infusing flavors from the flavoring material into the liquid stored in the infusion water bottle; and
a base configured to be removably secured to the bottom portion of the body, wherein the base is further configured to receive the infuser for allowing the liquid to enter and exit the infuser.

10. The infusion water bottle of claim 9, wherein the infuser comprises:
a flange comprising a plurality of threads annularly for threadably securing the infuser to an inner surface of the bottom portion of the body; and
a wall portion defined by a plurality of openings, wherein the wall portion is extended downwardly from the flange.

11. The infusion water bottle of claim 9, wherein the base comprises a plurality of threads annularly formed around an opening top of the base for threadably engaging to an outer surface of the bottom portion of the body.

12. The infusion water bottle of claim 9, wherein the removable closure comprises a strap to enable a user for holding the infusion water bottle.

13. The infusion water bottle of claim 9, wherein the infuser is of a cone shape.

14. The infusion water bottle of claim 9, wherein the body of infusion water bottle is made of a polymer resin comprising at least one of Tritan®, silicone, and stainless steel.

15. (canceled)

16. The infusion water bottle of claim 9, wherein the flavoring material comprises at least one additive selected from the group including natural flavors of fruits and vegetables, nature-identical flavors of fruits and vegetables, artificial flavors of fruits and vegetables, and pieces of fruits and vegetables.
